(19) United States
(12) Patent Application Publication
(10) Pub. No.: US 2011/0235097 A1
(43) Pub. Date: Sep. 29, 2011

(54) INFORMATION PROCESSING DEVICE, PRINTER, INFORMATION PROCESSING METHOD, AND RECORDING MEDIUM

(75) Inventor: Masayuki Iwasawa, Kanagawa (JP)

(73) Assignee: FUJI XEROX CO., LTD., Tokyo (JP)

(21) Appl. No.: 12/873,480

(22) Filed: Sep. 1, 2010

(30) Foreign Application Priority Data
Mar. 25, 2010 (JP) 2010-070593

(51) Int. Cl. G06F 3/12

(52) U.S. Cl. 358/1.15

(57) ABSTRACT

An information processing device of the present invention has: a receiving section that receives a print job transmitted by a sender; a printing executing section that, when a print job received at the receiving section is a print job to which authentication information is not added, executes printing immediately, and, when a print job received at the receiving section is an authentication-added print job to which the authentication information is added, stores the print job temporarily, and executes printing on the basis of authentication of a person who carries out printing; and a notification section that, when printing of the authentication-added print job has been executed at the printing executing section, notifies the sender of the print job that printing of the print job has been executed.

### CROSS-REFERENCE TO RELATED APPLICATION

This application is based on and claims priority under 35 USC 119 from Japanese Patent Application No. 2010-070593 filed on Mar. 25, 2010.

### BACKGROUND

### Technical Field

The present invention relates to an information processing device, a printer, an information processing method, and a recording medium.

### SUMMARY

The present invention provides an information processing device, a printer, an information processing method, and a recording medium that, when the sender who transmits a print job and the person who carries out printing of the print job are different, enables the sender who transmits the print job to recognize that printing has been completed.

An information processing device of a first aspect of the present invention includes: a receiving section that receives a print job transmitted by a sender; a printing executing section that, when a print job received at the receiving section is a print job to which authentication information is not added, executes printing immediately, and, when a print job received at the receiving section is an authentication-added print job to which the authentication information is added, stores the print job temporarily, and executes printing on the basis of authentication of a person who carries out printing; and a notification section that, when printing of the authentication-added print job has been executed at the printing executing section, notifies the sender of the print job that printing of the print job has been executed.

### BRIEF DESCRIPTION OF THE DRAWINGS

Exemplary embodiments of the present invention will be described in detail based on the following figures, wherein:

FIG. 1 is a schematic drawing of a printing system relating to an exemplary embodiment;

FIG. 2 is a block diagram showing hardware structures of a print server relating to the present exemplary embodiment;

FIG. 3 is a functional block diagram based upon processings executed at a CPU of the print server relating to the present exemplary embodiment;

FIG. 4 is a security judgment condition table that is used in judgment processing at a judging section;

FIG. 5 is a user list table that is used when an authentication request instruction adding section adds an authentication request to a print job;

FIG. 6 is a block diagram showing the hardware structures of an image forming device relating to the present exemplary embodiment;

FIG. 7 is a functional block diagram based upon processings executed at a CPU of the image forming device of the present exemplary embodiment;

FIG. 8 is a group confidential box table relating to the present exemplary embodiment;

FIG. 9 is a diagram showing confidential boxes that are set at the image forming device relating to the present exemplary embodiment;

FIG. 10 is a flowchart showing operations of the print server in the printing system relating to the present exemplary embodiment;

FIG. 11 is a front view of recording sheets that are printed in the printing system relating to the present exemplary embodiment;

FIG. 12 is a diagram of the flow up until the generation of an extracted information table by the extracting of information from a banner sheet relating to the present exemplary embodiment;

FIG. 13 is a diagram of the flow up until the generation of an extracted information table by the extracting of information from a form page relating to the present exemplary embodiment;

FIG. 14 is a flowchart that explains details of authentication setting processing shown in step 105 of FIG. 10, relating to the present exemplary embodiment;

FIG. 15 is a flowchart for explaining operation of the image forming device that has received a print job, relating to the present exemplary embodiment;

FIG. 16 is a flowchart showing the flow of managing control of a print job stored in a print job storing section of the image forming device, relating to the present exemplary embodiment; and

FIG. 17 is a flowchart showing the flow of control for notifying the completion of printing processing by the image forming device, relating to the present exemplary embodiment.

### DETAILED DESCRIPTION

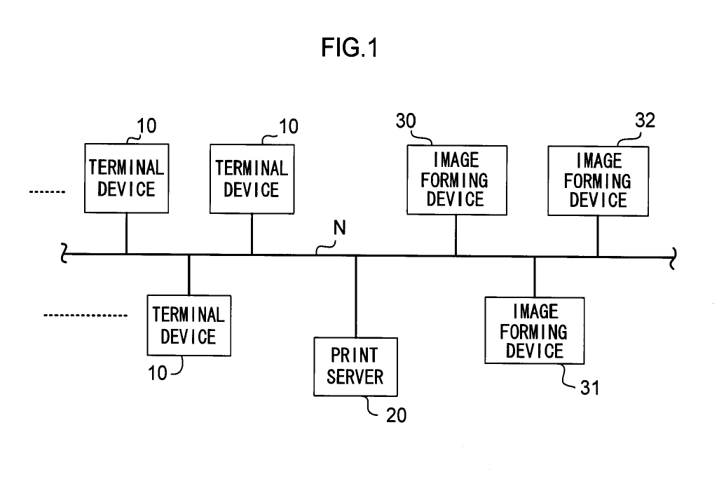

A printing system relating to an exemplary embodiment is shown in FIG. 1. Terminal devices 10 generate print jobs, and transmit the generated print jobs to a print server 20 via a communication line network N.

Here, a print job expresses information that is described in page description language, and is information of a form that an image forming device can interpret, and is information that is interpreted by an image forming device and converted into bitmap data.

The print server 20 functions as a print control device, and transmits a received print job to any of image forming devices 30 through 32. Note that there are also cases in which the print server 20 transmits a print job to plural image forming devices among the image forming devices 30 through 32. The image forming devices 30 through 32 receive print jobs transmitted from the print server 20, and output images that are based on the received print jobs onto printing sheets.

(Print Server 20)

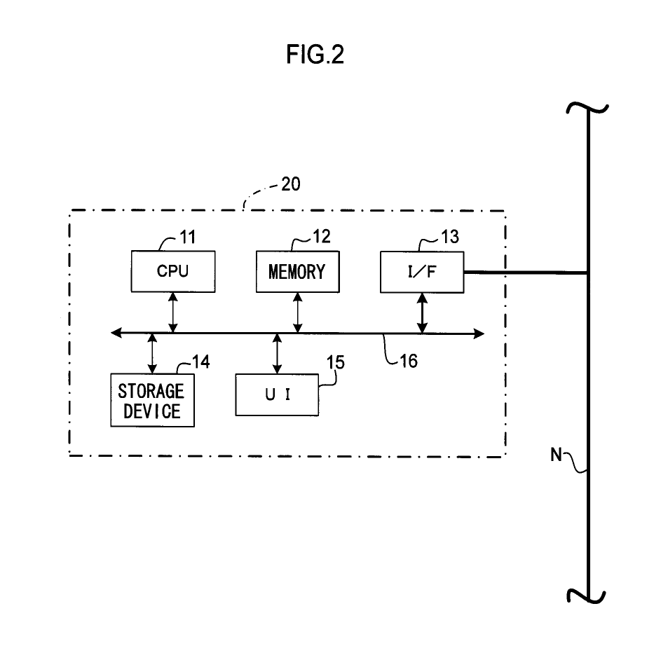

As shown in FIG. 2, the print server 20 has a CPU 11, a memory 12, a communication interface (I/F) 13 that carries out transmission and receipt of data with external devices and the like, a storage device 14 such as a hard disk drive (HDD) or the like, and a user interface (UI) 15 that includes a touch panel or a liquid crystal display and a keyboard. These structural elements are connected to one another via a control bus 16.

The CPU 11 executes predetermined processings on the basis of control programs that are stored in the memory 12 or the storage device 14, and controls the operations of the print server 20. Note that, in the present exemplary embodiment, explanation is given of a case in which the CPU 11 reads-out and executes control programs that are stored in the memory 12 or the storage device 14. However, these programs can be stored on a recording medium such as a CD-ROM or the like and provided to the CPU 11.

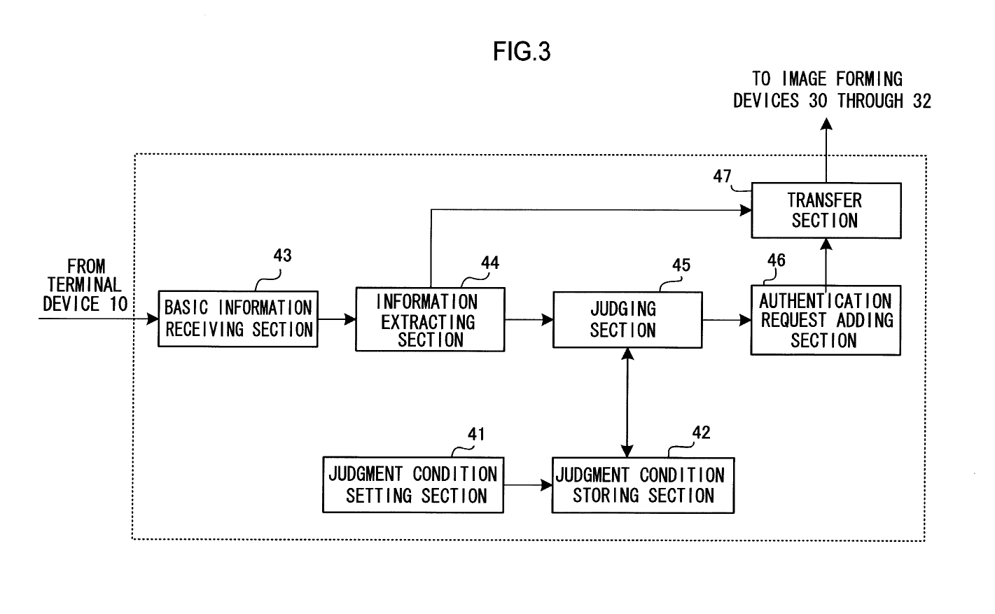

The print server 20 receives basic information for printing from the terminal device 10. On the basis of whether or not authentication is to be carried out, and the attributes of the image forming devices connected on the communication line network N, and the like, the print server 20 generates a print job and stores the print job, and sends the print job out to the image forming device 30 through 32. FIG. 3 is a block diagram showing the functional structures from generation of a print job to the sending-out of the print job, that are executed mainly at the CPU 11.

As shown in FIG. 3, a judgment condition setting section 41 sets security judgment conditions for judging whether or not a received print job is a print job that requires authentication when carrying out printing processing on the basis of that print job.

For example, the judgment condition setting section 41 sets, as the security judgment conditions, whether or not any one of or combination of at least two or more of information that are the print job name (print instruction name), the title, the output destination, the user name and the customer name of the print job, matches information that has been set in advance. A judgment condition storing section 42 stores the security judgment conditions that are set by the judgment condition setting section 41.

A basic information receiving section 43 receives basic information that is transmitted-in from the terminal devices 10. Note that the basic information is text information for generating a print job, and is sent-in divisionally from plural terminal devices 10 or is sent-in successively in time sequence. This information is collected at the print server 20 and generated as a print job.

A received information extracting section 44 extracts specific information, that is set in advance, from the basic information that is received by the basic information receiving section 43.

A judging section 45 judges whether or not the basic information that is received by the basic information receiving section 43 matches the security judgment conditions that are set by the judgment condition setting section 41. Specifically, the judging section 45 judges whether or not the information extracted by the information extracting section 44 matches the security judgment conditions that are set by the judgment condition setting section 41.

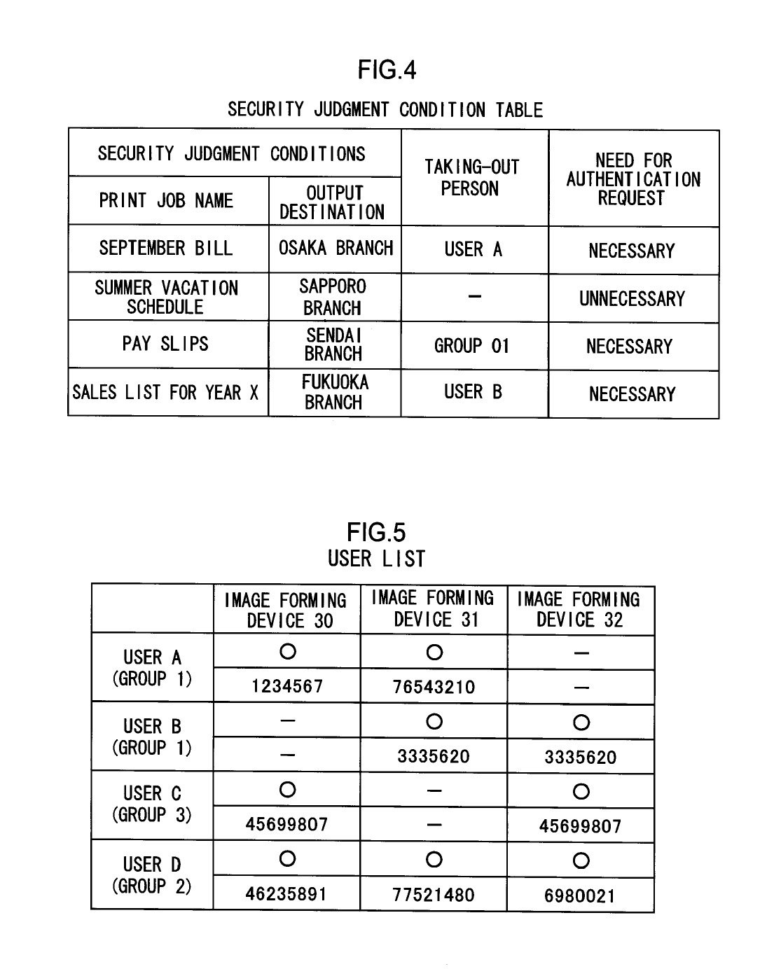

The security judgment condition table shown in FIG. 4 is used at the time of the judgment processing that the judging section 45 carries out.

In the security judgment condition table shown in FIG. 4, conditions that are the name of the print job and the output destination are set as the security judgment conditions. For example, for a print job for which “September bill” is set as the print job name and “Osaka branch” is set as the output destination, condition setting that is such that it is judged that an authentication request is needed is carried out. Further, for this print job, setting is carried out such that “user A” is designated as the recipient.

As shown in FIG. 3, when a print job that was received by the basic information receiving section 43 has been judged at the judging section 45 to match the security judgment conditions, an authentication request instruction adding section 46 adds an authentication request instruction to that print job. When an authentication request instruction has been added, printing of the print job onto a sheet is not carried out, and printing of the print job onto a sheet is carried out when authentication, such as authentication of the user or the like, is carried out. Namely, when an authentication request instruction has been added, the printing is handled as confidential printing. Note that an authentication request instruction is used as an example of information expressing that a print job is a print job for which authentication is needed when printing processing on the basis of the print job is carried out.

Concretely, the authentication request instruction adding section 46 adds an authentication request instruction to a print job that is to be transferred from the transfer section 47, by setting a recipient and a password.

FIG. 5 shows an example of a user list that is used when the authentication request instruction adding section 46 adds an authentication request to a print job.

For example, when “user A” has been designated as the recipient at the judging section 45, on the basis of the user list shown in FIG. 5, the authentication request instruction adding section 46 sets “1234567” as the password if the output destination is the image forming device 30, and sets “76543210” as the password if the output destination is the image forming device 31. Note that, if a group has been designated as the recipient, the authentication request instruction adding section 46 sets only the fact that an authentication request is needed, and the recipient, at the print job.

The transfer section 47 transfers, to the image forming device 30 through 32, the print job that has been received from the basic information receiving section 43 and to which an authentication request instruction has been added by the authentication request instruction adding section 46.

(Image Forming Devices 30 Through 32)

Because the basic control structures of the image forming devices 30 through 32 are similar, the structure of the image forming device 30 is described hereinbelow.

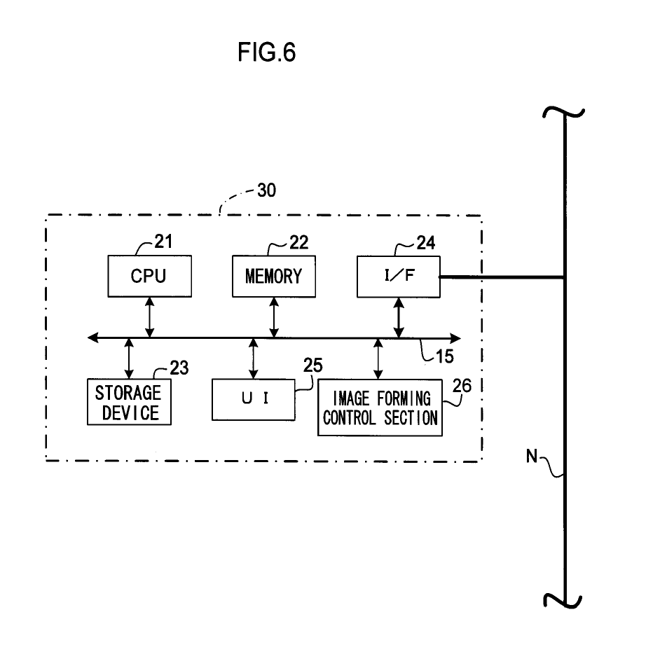

As shown in FIG. 6, the image forming device 30 has a CPU 21, a memory 22, a storage device 23 such as a hard disk drive (HDD) or the like, an interface (I/F) 24 that carries out transmission and receipt of data with external devices or the like via the communication line network N, a user interface (U/I) 25 including a touch panel or a liquid crystal display and a keyboard, and an image formation control section 26. These structural elements are connected to one another via a control bus 25.

The CPU 21 executes predetermined processings on the basis of control programs that are stored in the memory 22 or the storage device 23, and controls the operations of the image forming device 30. Note that, in the present exemplary embodiment, explanation is given of a case in which the CPU 21 reads-out and executes control programs that are stored in the memory 22 or the storage device 23. However, the programs can be stored on a recording medium, such as a CD-ROM or the like, and presented to the CPU 21.

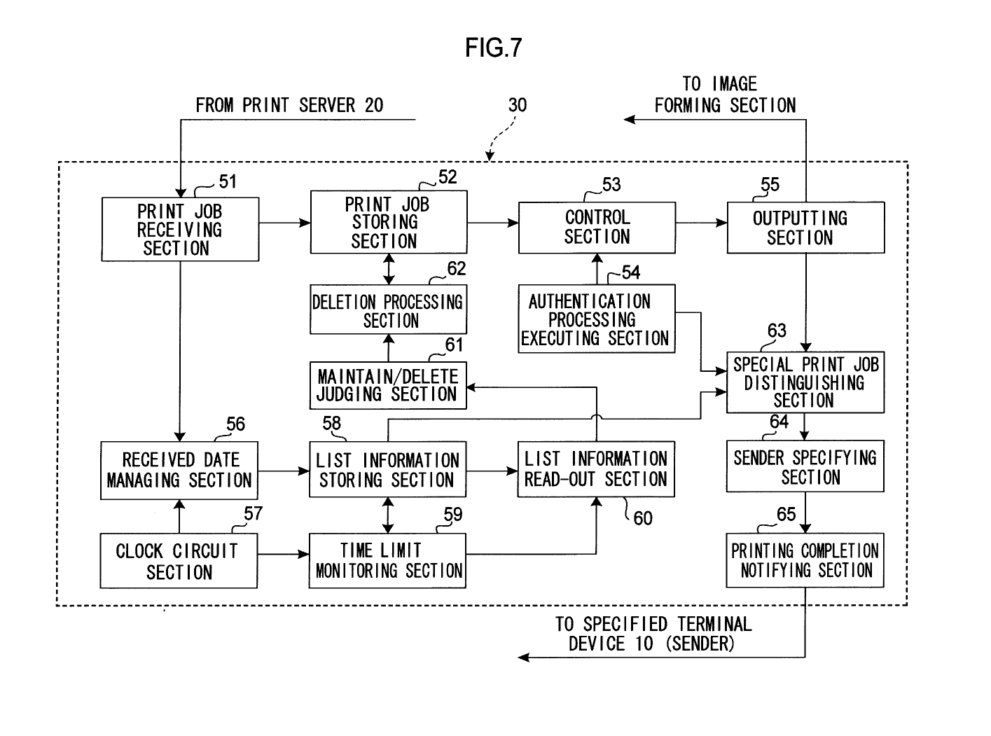

When the image forming device 30 receives a print job, the image forming device 30 forms an image on a predetermined recording sheet. FIG. 7 is a block diagram showing the functional structures of image forming processing that is based on a print job and that is executed mainly by the CPU 21.

As shown in FIG. 7, a print job receiving section 51 receives a print job that is transmitted-in from the print server 20. A print job storing section 52 stores the print job that is received by the print job receiving section 51.

In accordance with control of a control section 53, an outputting section 55 outputs an image on the basis of the print job received by the print job receiving section 51 and stored in the print job storing section 52. The control section 53 controls the image outputting processing at the outputting section 55.

When an authentication request instruction has been added to a print job for which image outputting processing is to be carried out, an authentication processing executing section 54 executes authentication processing before the print job is executed at the outputting section 55. The authentication processing that is carried out by the authentication processing executing section 54 here may be authentication processing such as inputting the password by keyboard input or the like, or may be authentication processing using an IC card or the like. Or, a method based on physiological information using a fingerprint, vein pattern, iris pattern, or the like may be used for the authentication processing.

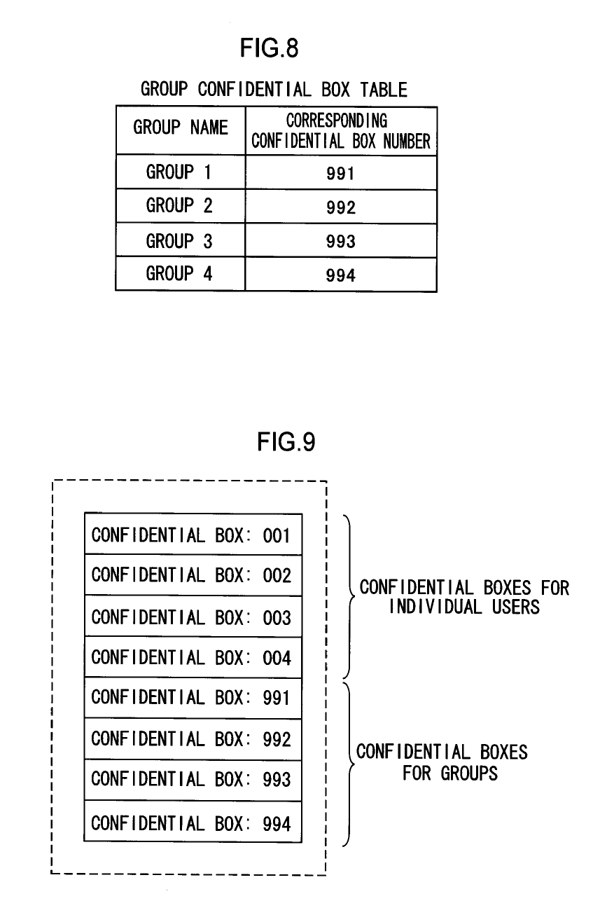

Note that, when an authentication request instruction in which a group is designated as the recipient has been added to a print job for which image outputting processing is to be carried out, a confidential box in which the print job should be stored is designated on the basis of a group confidential box table such as shown in FIG. 8, and the print job is stored in that confidential box.

An example of confidential boxes that are set at the image forming device is shown in FIG. 9. In the example shown in FIG. 9, confidential boxes “001” through “004” are set so as to store print jobs whose recipients are individual users, and confidential boxes “991” through “994” are set so as to store print jobs whose recipients are groups.

For example, a print job, to which is added an authentication request instruction in which group 1 is designated as the recipient, is stored in confidential box number “991”. In order to execute the print job stored in this confidential box number “991”, authentication processing by input of a password set in advance is required.

(Print Job Managing Control at Image Forming Device)

In the present exemplary embodiment, if a print job received at the image forming device 30 through 32 does not have an authentication request instruction, printing processing is successively executed, and therefore, the time period over which the print job is stored in the print job storing section 52 is relatively short. However, if there is an authentication request instruction, the print job is stored in the print job storing section 52 until the authorized recipient carries out a printing instruction, and the time period that the print job is stored this time is relatively long. In other words, the more the number of print jobs having authentication request instructions increases, the more the storage area of the print job storing section 52 is used-up.

Thus, the following measures are carried out in the present exemplary embodiment.

(Measure 1) A print job, for which authentication is requested and for which a predetermined time period has elapsed, is forcibly deleted.

(Measure 2) If the print job sender and recipient are different, the deletion processing of measure 1 is prohibited.

In the following description, a print job whose sender and recipient are different may be referred to as a “special print job”.

Measure 1 aims to effectively utilize the limited storage capacity of the print job storing section 52 by successively deleting old print jobs.

Measure 2 focuses on the fact that not all old print jobs are unnecessary print jobs, and aims to narrow the range of print jobs that are objects of execution of measure 1 by prohibiting the deletion processing of measure 1 when a predetermined condition is established (in the present exemplary embodiment, the condition that the print job is a special print job is established).

Functional blocks for executing measure 1 and measure 2 are added to above-described FIG. 7.

Namely, a received date managing section 56 (reception section) is connected to the print job receiving section 51 shown in FIG. 7. A clock circuit section 57 is connected to the received date managing section 56, and the current year/month/date information is always inputted to the received date managing section 56. Therefore, when the print job receiving section 51 receives a new print job, the received date managing section 57 acquires list information for specifying the print job, and sends it to a list information storing section 58 together with the acquired year/month/date information.

Note that the list information may be, for example, a serial number, an identification number, or the like, and is not limited provided that it can specify the print job. However, the list information includes authentication information as necessary information. The need or lack thereof for authentication, and the sameness of the sender and the receiver, are included in the authentication information here. Note that the device may be structured such that, if a print job stored in a confidential box can be specified at this point in time, the print job that is stored in that confidential box is extracted. Only the sameness of the sender and the receiver is needed as the authentication information in this case.

The list information that specifies the print job and the acquired year/month/date information are made into a database as a pair and are stored in the list information storing section 58.

A time limit monitoring section 59 is connected to the clock circuit section 57. The time limit monitoring section 59 is connected to the list information storing section 58, and has the function of monitoring the time period that has elapsed from the start of storage of each of the print jobs.

When the time limit monitoring section 59 recognizes that there is a print job whose predetermined time limit has elapsed, the time limit monitoring section 59 sends that information to a list information read-out section 60. The list information read-out section 60 reads-out the list information whose time limit has expired, and sends it to a maintain/delete judging section 61.

Namely, the print job, that corresponds to the list information read-out by the list information read-out section 60, becomes a candidate for an object of deletion.

The maintain/delete judging section 61 is connected to a deletion processing section 62, and, as a rule, outputs deletion instructing commands. On the basis of the deletion instructing command, the deletion processing section 62 specifies the pertinent print job from the print job storing section 52, and executes deletion processing (measure 1).

Here, on the basis of the authentication information in the read-out list information, the maintain/delete judging section 61, as an exception, prohibits the outputting of a deletion instructing command (measure 2) for a print job for which an authentication request is needed and for which it is judged that the sender and the recipient are different.

Namely, the maintain/delete judging section 61 has the functions of, as a rule, receiving authentications, and, as an exception, excluding, from the objects of deletion, a special print job (an authentication-added print job at which the sender and the recipient are different), from among the authentication-added print jobs that are stored in the print job storing section 52, even if the predetermined time limit thereof has passed.

(Control of Notification of Printing Processing Completion of a Special Print Job at Image Forming Device)

As described above, a special print job is a print job at which the sender and the recipient are different. Therefore, in order for the sender to confirm whether or not the recipient has reliably received the print job, information must be transferred separately outside of the printing system of the present exemplary embodiment, such as the sender must send an inquiry to the recipient, or must receive notification of receipt based upon an advance arrangement with the recipient.

Thus, the image forming devices 30 through 32 of the present exemplary embodiment automatically execute, in the printing system, notification to the sender of completion of printing for special print jobs. Functional blocks relating to printing completion notification are shown in FIG. 7.

As shown in FIG. 7, a special print job distinguishing section 63 is connected to the outputting section 55. Notification of completion of printing processing of a print job is sent from the outputting section 55 to the special print job distinguishing section 63. Note that the outputting section 55 may specialize a print job into a print job for which authentication is needed (an authentication-added print job), and send notification of completion of printing processing to the special print job distinguishing section 63.

The special print job distinguishing section 63 is connected to the list information storing section 58.

When the special print job distinguishing section 63 receives notification of completion of printing processing of a print job from the outputting section 55, the special print job distinguishing section 63 acquires the list information of the print job for which printing processing has been completed from the list information storing section 58, and distinguishes whether or not that print job for which printing processing has been completed is a special print job.

The special print job distinguishing section 63 is connected to a sender specifying section 64. If, in the above distinguishing processing, the print job is distinguished as a special print job, the sender specifying section 64 specifies the sender and sends it to a printing completion notifying section 65.

At the outputting section 55, if it can be ascertained that a print job is an authentication-added print job and is a special print job at which the sender and receiver are different, it suffices to acquire only the special print job from the outputting section 55. Therefore, information from the list information storing section 48 is not needed, and notification of completion of printing of the special print job may be sent directly to the sender specifying section 64.

The printing completion notifying section 65 notifies the specified sender that printing has been competed. Note that the notifying section is not limited, and may provide notice by transmission through the particular communication line network N through which print jobs are transmitted and received, mail through the internet, a fax through a telephone line network, notification to a cell phone, or the like.

Operation of the printing system of the present exemplary embodiment is described next.

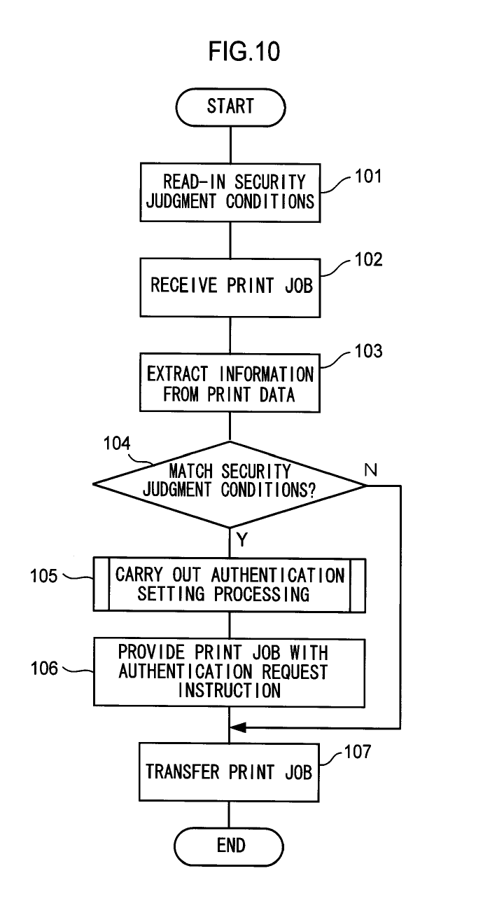

First, operation of the print server 20 in the printing system of the present exemplary embodiment is described with reference to the flowchart of FIG. 10.

At the print server 20, the judging section 45 reads-in, in advance, the security judgment conditions from the judgment condition storing section 42 (step 101).

Then, when the basic information receiving section 43 receives a print job from the terminal device 10 (step 102), the information extracting section 44 extracts information from the print job (step 103).

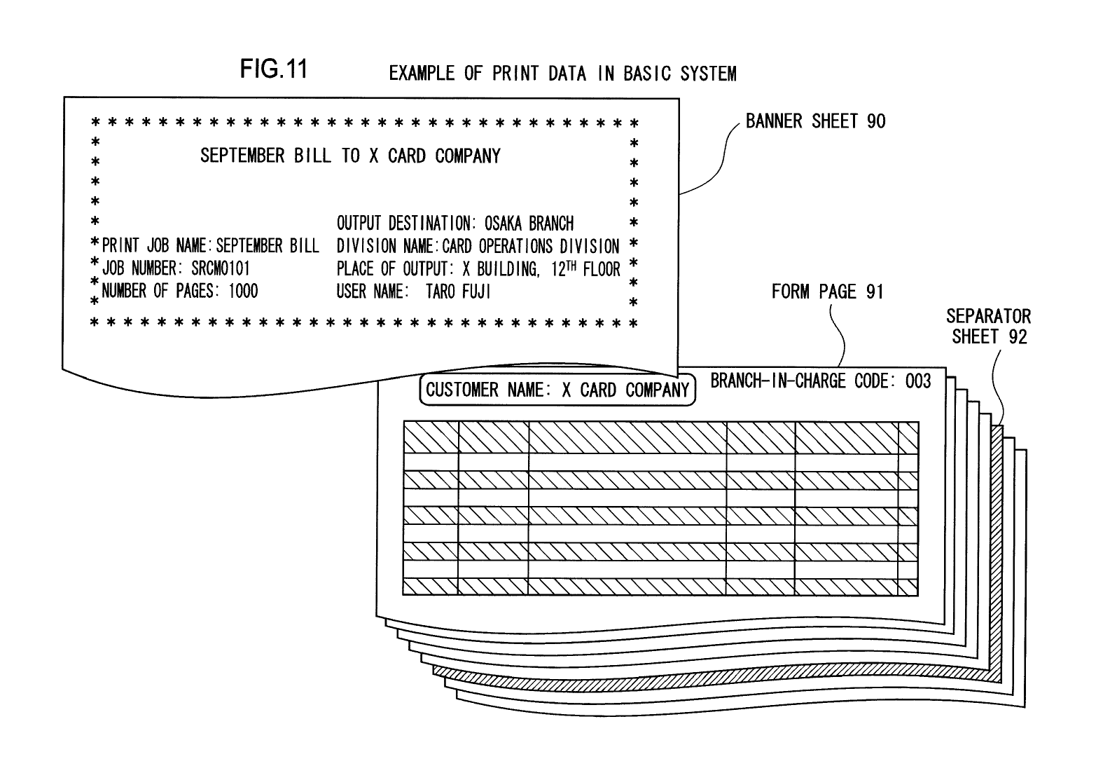

Concrete description will be given by using, as an example, a case in which the print data shown in FIG. 11 is received. The print data shown in FIG. 11 is structured such that the leading page is a banner sheet 90 that includes various types of information, and plural form pages 91 that are actually used continue in the following pages. A separator sheet 92 is provided at the boundary between this print data and other print data.

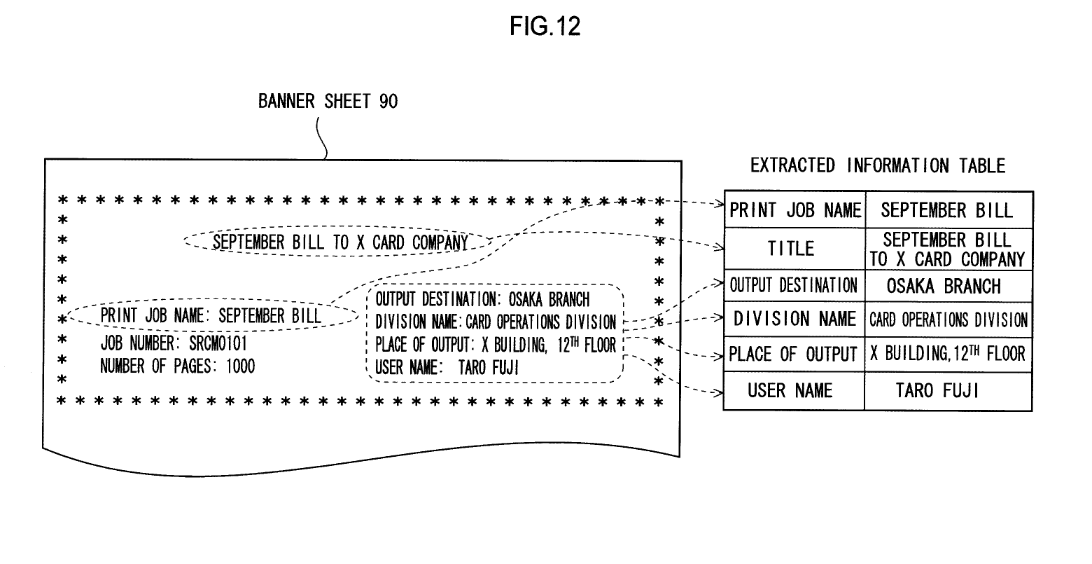

For example, when information is extracted from the banner sheet 90, as shown in FIG. 12, the information extracting section 44 extracts the information such as the title, the output destination, the division name, the place of output, and the user name, and generates an extracted information table.

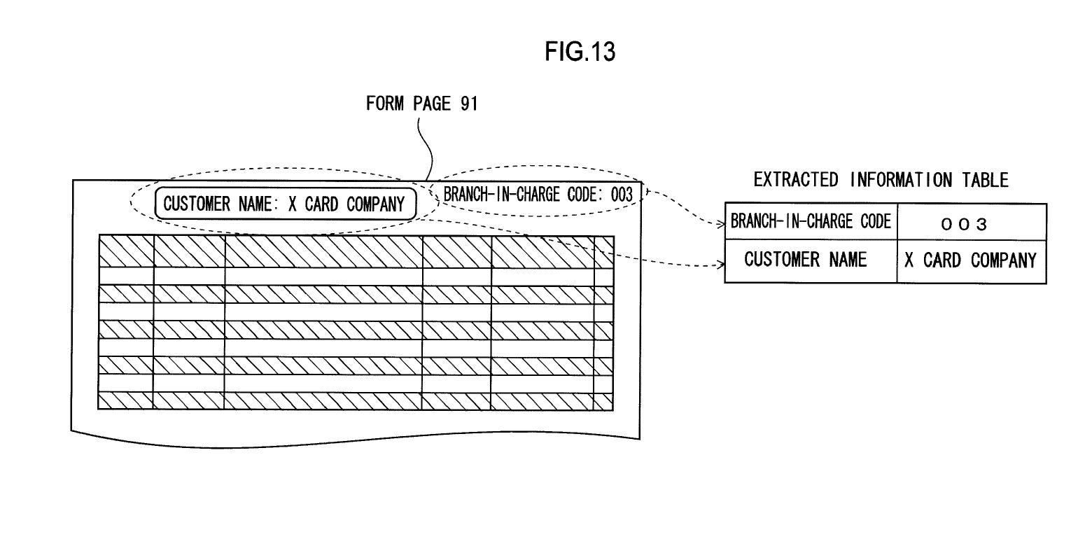

Further, when information is extracted from the form pages 91, as shown in FIG. 13, the information extracting section 44 extracts information such as the code of the branch in charge, the name of the customer, and the like, and generates an extracted information table.

On the basis of the extracted information tables generated by the information extracting section 44, the judging section 45 judges (step 104) whether or not a print job that is to be transferred matches the security judgment conditions that were read-in from the judgment condition storing section 42.

Various types of authentication setting processings are carried out (step 105) in order to set an authentication request instruction at the print job. Details of the authentication setting processing are described hereinafter.

The authentication request instruction adding section 46 adds an authentication request instruction to the print job (step 106). The transfer section 47 transfers the print job, to which the authentication request instruction has been added, to the image forming device 30 through 32 (step 107).

Note that, in step 104, if it is judged that the print job that is to be transferred does not match the security judgment conditions, the print job received by the basic information receiving section 43 is transferred to the image forming device 30 through 32 by the transfer section 47 without an authentication request instruction being added thereto.

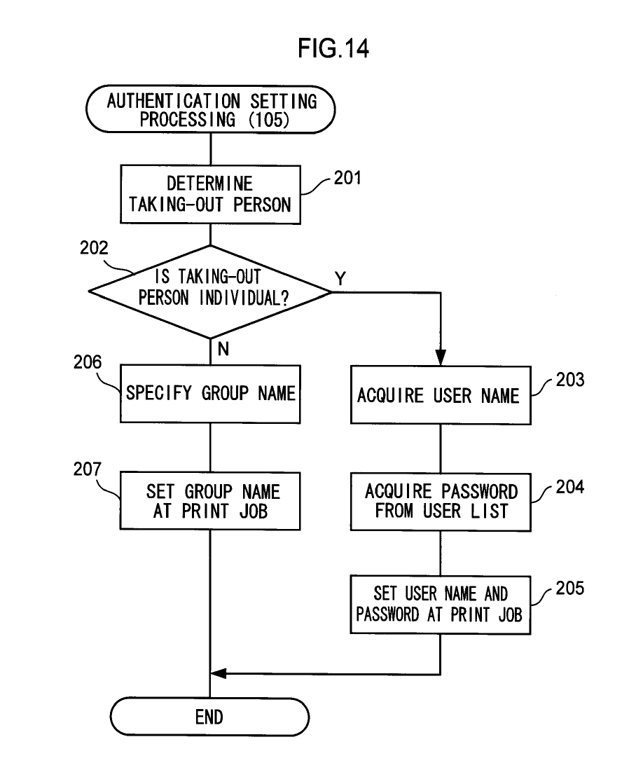

Details of the authentication setting processing shown in step 105 of FIG. 10 will be described next with reference to the flowchart of FIG. 14.

In the authentication setting processing, determining of the recipient is carried out (step 201) on the basis of a security judgment condition table such as shown in FIG. 4. If the recipient is an individual (Yes in step 202), setting of a password is carried out (step 203 through step 205).

In step 202, if it is judged that the recipient is a group and not an individual (No in step 202), specifying of the group name and setting of the group name for the print job are carried out (step 206, step 207).

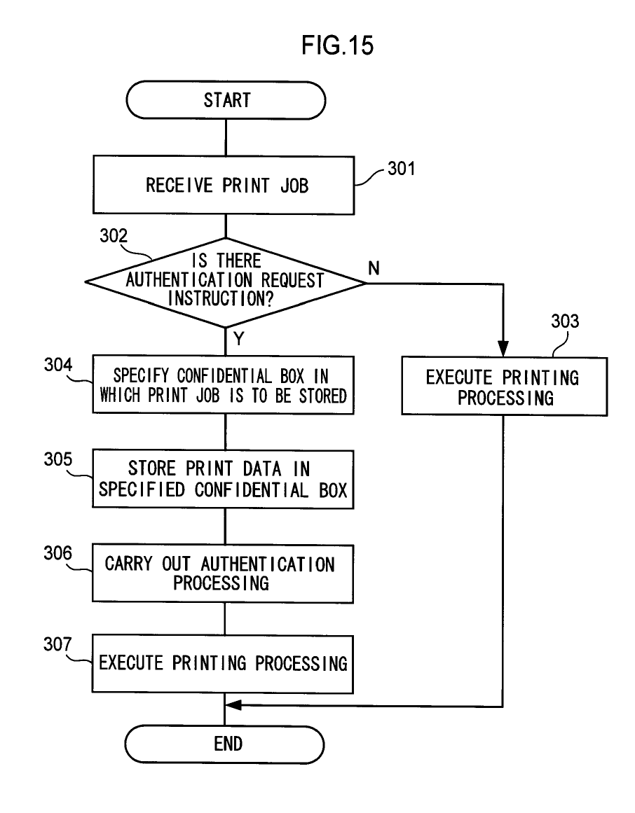

Operation when a print job, to which an authentication request instruction is added in this way, is received at the image forming device 30 is described with reference to the flowchart of FIG. 15.

When a print job from the print server 20 is received at the print job receiving section 51 and is stored in the print job storing section 52 (step 301), the control section 53 judges whether or not an authentication request instruction is added to the print job (step 302).

In step 302, if it is judged that an authentication request instruction is not added to the received print job, usual printing processing in which an authentication request is not carried out is executed, and the outputting section 55 carries out image outputting processing that is based on the received print job (step 303).

In step 302, if it judged that an authentication request instruction is added to the received print job, the confidential box in which the print job is to be stored is specified (step 304), and the print data is stored in the specified confidential box (step 305).

When a user carries out image outputting processing of the print job, an authentication request, such as a request for password input or the like, is carried out. If normal authentication processing is carried out (step 306), image outputting processing that is based on the received print job is carried out at the outputting section 55 (step 307).

(Flow of Print Job Managing Control)

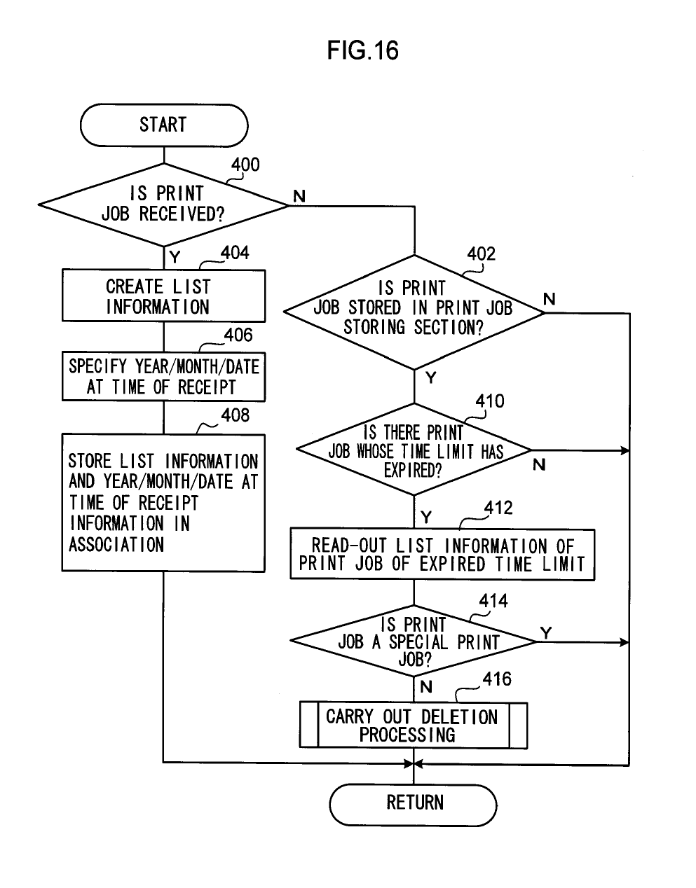

The flow of the control of managing stored print data (print job managing control) will be described in accordance with the flowchart of FIG. 16. This control is executed in accordance with the processing executed in step 305 (“store print data in specified confidential box”) in the printing processing operation (the flowchart of FIG. 15) at the image forming device 30 through 32.

In step 400, it is judged whether or not a print job has been received. If the judgment is negative, the routine move on to step 402, and it is judged whether or not a print job is stored in the print job storing section 52. If the judgment in step 402 is negative, the routine ends.

If the judgment in step 400 is affirmative, control becomes print job registration mode control, and the routine move on to step 404.

In step 404, list information is generated on the basis of the received print job. Then, the routine moves on to step 406 where year/month/date at time of receipt information is acquired, and the routine proceeds to step 408. In step 408, the list information and the year/month/date at time of receipt information are stored in association with one another in the list information storing section 58, and the routine ends.

On the other hand, if the judgment in step 402 is affirmative, control becomes print job deletion mode control, and the routine moves on to step 410.

In step 410, it is judged whether or not, among the print jobs that are stored in the print job storing section 52 (it may be specialized to within a confidential box), there is a print job whose time limit has expired. If the judgment is negative, it is judged that there are no print jobs that are objects of deletion, and the routine ends.

If the judgment in step 410 is affirmative, it is judged that there exists a print job that is an object of deletion, and the routine moves on to step 412. At this point in time, a print job corresponding to above-described measure 1 is selected.

In step 412, the list information of the print job of the expired time limit is read-out from the list information storing section 58. Next, the routine moves on to step 414 where it is judged whether or not the read-out print job is a special print job, i.e., whether or not the read-out print job is an authentication-added print job whose sender and recipient are different.

In step 414, if the judgment is negative, it is judged that the sender and the recipient are the same. The routine proceeds to step 416 where that authentication-added print job is deleted from the print job storing section 52, and the routine ends (processing as a general rule in accordance with measure 1). Further, if the judgment in step 414 is affirmative, there is the possibility that the print job remains without having been printed due to negligence in contacting the recipient. Therefore, the print job is left as is without being deleted, and the routine ends. In this way, as an exception, deletion of a special print job is avoided, and above-described measure 2 is realized.

(Flow of Control of Notification of Completion of Printing Processing of Special Print Job)

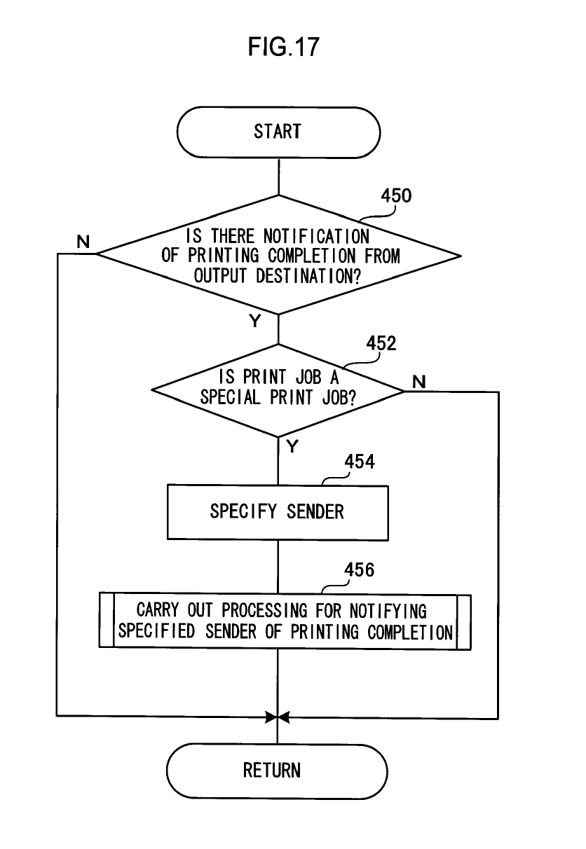

The flow of notifying the sender of completion of printing of a special print job is described next in accordance with the flowchart of FIG. 17. This control is executed in accordance with the processing executed in step 307 (“execute printing processing” in the printing processing operation (the flowchart of FIG. 15) at the image forming device 30 through 32.

In step 450, the special print job distinguishing section 63 judges whether or not notification of completion of printing has been received from the outputting section 55. If the judgment is negative, the routine ends.

If the judgment in step 450 is affirmative, the routine moves on to step 452, and it is judged whether or not the print job is a special print job on the basis of information from the authentication processing executing section 54 and/or the list information storing section 58. If the judgment in step 452 is negative, there is no need to notify the sender of completion of printing, and therefore, the routine ends.

If the judgment in step 452 is affirmative, there is the need to notify the sender of completion of printing. Therefore, the routine proceeds to step 454, and the sender is specified.

In next step 456, the specified sender is notified of completion of printing, and the routine ends.

Note that, if the outputting section 55 has the function of judging whether or not a print job is a special print job, the special print job distinguishing section 63 is unnecessary. Namely, because all of the print jobs that are outputted from the outputting section 55 are special print jobs, it suffices to notify the senders of the special print jobs of completion of printing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a receiving section that receives a print job transmitted by a sender;
a printing executing section that, when a print job received at the receiving section is a print job to which authentication information is not added, executes printing immediately, and, when a print job received at the receiving section is an authentication-added print job to which the authentication information is added, stores the print job temporarily, and executes printing on the basis of authentication of a person who carries out printing; and
a notification section that, when printing of the authentication-added print job has been executed at the printing executing section, notifies the sender of the print job that printing of the print job has been executed.

2. The information processing device of claim 1, further comprising a distinguishing section that distinguishes whether or not the sender and the person who carries out printing of the authentication-added print job are different,
wherein, when the distinguishing section has distinguished that the sender and the person who carries out printing are different, the notification section notifies the sender of the print job that printing of the print job has been executed.

3. The information processing device of claim 1, further comprising a distinguishing section that distinguishes whether or not the authentication-added print job is a special print job,
wherein, when the distinguishing section has distinguished that the authentication-added print job is the special print job, the notification section notifies the sender of the print job that printing of the print job has been executed.

4. The information processing device of claim 3, wherein the distinguishing section is connected to a list information storing section in which list information that specifies the print job is made into a database and stored, and the list information is acquired from the list information storing section when the distinguishing section distinguishes whether or not the print job is the special print job.

5. A printer comprising:
the information processing device of claim 1,
wherein the printer receives a print job from a terminal device or a print server that is connected to the information processing device by a communication line network, and executes printing processing, and has a function of authenticating a recipient of the authentication-added print job.

6. An information processing method comprising:
receiving a print job transmitted by a sender;
when a received print job is a print job to which authentication information is not added, immediately executing printing, and, when a received print job is an authentication-added print job to which the authentication information is added, temporarily storing the print job, and executing printing on the basis of authentication of a person who carries out printing; and
when printing of the authentication-added print job has been executed, notifying the sender of the print job that printing of the print job has been executed.

7. A computer readable medium storing an information processing program that causes a computer to operate as the information processing device of claim 1.
